(19) United States
(12) Patent Application Publication
(10) Pub. No.: US 2025/0217770 A1
(43) Pub. Date: Jul. 3, 2025

(54) INFORMATION PROCESSING METHOD AND APPARATUS, AND A STORAGE MEDIUM

(71) Applicant: Beijing Zitiao Network Technology Co., Ltd., Beijing (CN)

(72) Inventors: Chunshuo YANG, Beijing (CN); Zhi YI, Beijing (CN); Hebiao TAN, Beijing (CN); Qianwen GUO, Beijing (CN)

(21) Appl. No.: 19/002,412

(22) Filed: Dec. 26, 2024

(30) Foreign Application Priority Data
Dec. 28, 2023 (CN) 202311845900.1

(51) Int. Cl. G06Q 10/10

(52) U.S. Cl. CPC G06Q 10/103

(57) ABSTRACT

Embodiments of the present disclosure disclose an information processing method, and an electronic device. A specific implementation of the method includes: establishing, in a project management system, a dependency relationship between a first sub-object of a first work item and a second sub-object of a second work item based on a dependency configuration operation; and displaying, in a first work item display interface, dependency relationship information indicating the dependency relationship. Therefore, a new information processing manner is provided. The dependency relationship is used to represent that opening or completion of the first sub-object depends on a status of the second sub-object.

### CROSS-REFERENCE TO RELATED APPLICATION

This application claims the priority to and benefits of the Chinese Patent Application, No. 202311845900.1, which was filed on Dec. 28, 2023. The aforementioned patent application is hereby incorporated by reference in its entirety.

### TECHNICAL FIELD

The present disclosure relates to the field of computer technologies, and in particular, to an information processing method and apparatus, and an electronic device.

### BACKGROUND

With the development of computers, a user can use electronic devices to implement various functions. For example, a user can interact with another user by using an electronic device, and can also use the electronic device to promote work.

In some scenarios, a tool or a platform based on data management (for example, a project management system) may be constructed. By creating a standardized business process, project launch can be accelerated, and project risks can be avoided.

### SUMMARY

The present disclosure section is provided to give a brief overview of concepts, which will be described in detail later in the section of Detailed Description of Embodiments. This section is neither intended to identify key features or necessary features of the claimed technical solution, nor is it intended to limit the scope of the claimed technical solution.

According to a first aspect, an embodiment of the present disclosure provides an information processing method, the method including: establishing, in a project management system, a dependency relationship between a first sub-object of a first work item and a second sub-object of a second work item based on a dependency configuration operation; and displaying, in a first work item display interface, dependency relationship information indicating the dependency relationship, wherein the dependency relationship is used to represent that opening or completion of the first sub-object depends on a status of the second sub-object.

According to a second aspect, an embodiment of the present disclosure provides an information processing apparatus, including: an establishment unit, configured to establish, in a project management system, a dependency relationship between a first sub-object of a first work item and a second sub-object of a second work item based on a dependency configuration operation; and a display unit, configured to display, in a first work item display interface, dependency relationship information indicating the dependency relationship, wherein the dependency relationship is used to represent that opening or completion of the first sub-object depends on a status of the second sub-object.

According to a third aspect, an embodiment of the present disclosure provides an electronic device, including: one or more processors; and a storage apparatus, configured to store one or more programs, wherein the one or more programs, when executed by the one or more processors, cause the one or more processors to implement the information processing method according to the first aspect.

According to a fourth aspect, an embodiment of the present disclosure provides a computer-readable medium having a computer program stored thereon, wherein the program, when executed by a processor, causes the steps of the information processing method according to the first aspect to be implemented.

### BRIEF DESCRIPTION OF DRAWINGS

The above and other features, advantages, and aspects of embodiments of the present disclosure become more apparent in conjunction with the accompanying drawings and the following specific embodiments. Throughout the drawings, the same or similar reference numerals denote the same or similar elements. It should be understood that the accompanying drawings are schematic and that parts and elements are not necessarily drawn to scale.

FIG. 1 is a flowchart of an embodiment of an information processing method according to the present disclosure;

FIG. 2A, FIG. 2B, FIG. 2C, and FIG. 2D are schematic diagrams of an application scenario of the information processing method according to the present disclosure;

FIG. 3A, FIG. 3B, and FIG. 3C are schematic diagrams of an application scenario of the information processing method according to the present disclosure;

FIG. 4A, FIG. 4B, and FIG. 4C are schematic diagrams of an application scenario of the information processing method according to the present disclosure;

FIG. 5 is a schematic structural diagram of an embodiment of an information processing apparatus according to the present disclosure;

FIG. 6 is a schematic diagram of an exemplary system architecture in which an information processing method according to an embodiment of the present disclosure can be applied; and

FIG. 7 is a schematic diagram of a basic structure of an electronic device according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for illustrative purposes and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include” used herein and variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of other terms will be given in the description below.

It should be noted that the concepts of “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, it should be understood as “one or more”.

The names of messages or information exchanged between a plurality of apparatuses in the implementations of the present disclosure are for illustrative purposes only and are not used to limit the scope of these messages or information.

Here, for the convenience of description, some concepts that may be involved in the present disclosure are first described.

A space is a basic unit of organizing collaboration and may be management of a single project or a collection of a plurality of projects.

A work item is a work item collaborated by a team, and may also be a collection of items disassembled by a project. According to different contents, work items may be classified into different types, for example, a feature, an issue, a version, an iteration, a milestone, and the like.

A feature (Feature) may refer to a software function required by a user to solve a certain problem/achieve a certain goal, which can help team members to keep track of specific details.

An issue refers to a business requirement that does not conform to the initially defined requirement. For example, a pop-up window is not displayed, etc.

A view is a collection of query dimensions of work items frequently concerned in a team, which is solidified. The view may also be referred to as a view special item. A view may have various types, for example, a table, a list, a kanban, a Gantt chart, and a metric. A table may be an arrangement combination of field information in which data is arranged in a cell mode. A Gantt chart may display a project progress by using a bar chart in a time dimension. A metric is a continuous quantitative process of data definition, collection, and analysis of a software development project, a process, and its products. For example, requirements throughput, quality, cycle, and manpower estimation and assessment.

Source data is data for targeted measurement of the entire work item. For example, the source data may include a work item, such as a feature, an issue, a version, and an iteration. The source data may include view data, such as an in-progress feature pool, an issue to be processed by me, and a user-defined view name. The source data may include a single instance, for example, a data range is a specific feature, issue, version, iteration, and the like.

A role; various roles are involved in a project, and one project needs the cooperation and support of different roles.

A process is a basic step of a life cycle of an item, and is composed of process nodes and execution manners in an orderly manner. A node may refer to a stage division point of a process.

A root work item is a top-level work item, and may generally be named a project. The root work item may be associated with a general process of a project.

A sub-process node, which may also be referred to as a child node, is a node associated with a work item (namely, a child work item) that is disassembled in a process of a work item (a root work item or a parent work item of a non-root work item). Other sub-process nodes may be disassembled again in a process of the work item of the node, to implement process nesting. The work item of this node may not be further disassembled.

A sub-process work item is a work item associated with a sub-process node.

A task is a smallest unit of item (a special work item) and cannot be disassembled.

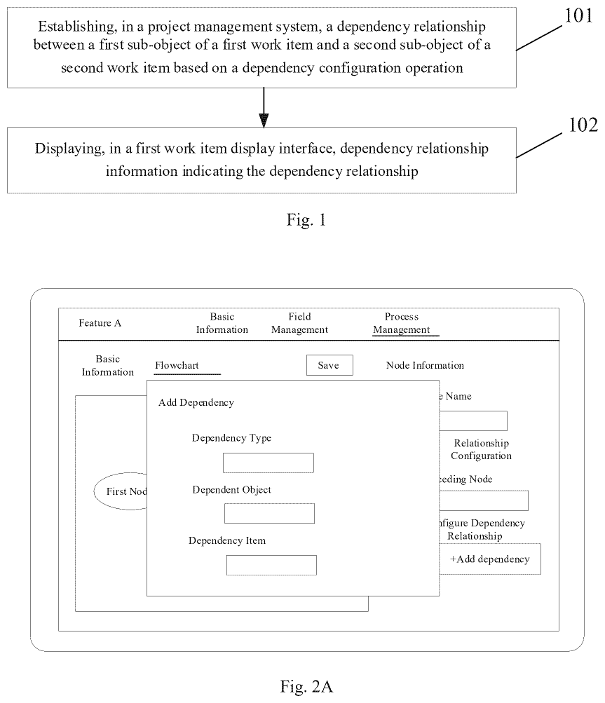

Reference is made to FIG. 1, which is a flowchart of an embodiment of an information processing method according to the present disclosure. As shown in FIG. 1, the information processing method includes the following steps.

Step 101: establishing, in a project management system, a dependency relationship between a first sub-object of a first work item and a second sub-object of a second work item based on a dependency configuration operation.

In this embodiment, an execution subject of the information processing method (for example, a server and/or a terminal device) may establish, in a project management system, a dependency relationship between a first sub-object of a first work item and a second sub-object of a second work item based on a dependency configuration operation.

The sub-object of the work item may include but is not limited to at least one of the following: a sub-process node of the work item and a subtask of the work item. The sub-process node may be a direct sub-process node of the work item; or may be an indirect sub-process node of the work item, for example, a sub-process node of a sub-process node of the work item. The subtask may be a direct subtask of the work item; or may be an indirect subtask of the work item, for example, a subtask of a subtask of the work item.

That is, the first sub-object includes a sub-process node and/or a subtask of the first work item, and the second sub-object includes a sub-process node and/or a subtask of the second work item.

Optionally, the dependency configuration operation may be implemented before a work item is generated and also may be implemented after the work item is generated. For example, a dependency relationship of a sub-object may be configured on a configuration side of the work item. For example, a dependency relationship of a sub-object may be configured on an instance side of the work item.

Step 102: displaying, in a first work item display interface, dependency relationship information indicating the dependency relationship.

Herein, the execution subject may display, in a first work item display interface, dependency relationship information indicating the dependency relationship.

Herein, the dependency relationship information is used to represent that opening or completion of the first sub-object depends on a status of the second sub-object. The status of the second sub-object may include a status that the progress of the second sub-object is in, for example, opening, opened for a preset duration, closed, completed, or completed for a preset duration, etc.

Herein, the first work item display interface may be configured to display related information of the first work item, for example, a flowchart of the first work item, a sub-process node of the first work item, and a subtask of the first work item. Optionally, the first work item display interface may be a work item details page, or the first work item display interface may be a configuration side interface for configuring the first work item.

It should be noted that, in the information processing manner provided in this embodiment, a dependency relationship may be established between sub-objects of a work item according to a dependency configuration operation, so that a granularity of the dependency relationship is improved, flexible dependence between the sub-objects in the work item is implemented, and clear management of manpower and progress promotion in the work item is improved.

For example, in a software production and research project scenario: in a feature development process, there is a dependence between features, or there is a dependence between tasks under the features, and a capability of establishing a dependency is required, to clearly manage manpower and progress coordination in the work. In a hardware project scenario: various processes of a hardware research and development process are relatively fixed, and different processes correspond to different work items. It is required to preset a fixed dependency relationship in processes of different work items.

In some embodiments, the first work item and the second work item have any one of the following relationships: the second work item and the first work item are the same work item; the second work item and the first work item are different work items belonging to a same project space; or the second work item and the first work item belong to different project spaces.

In some embodiments, the dependency configuration operation includes at least one of the following sub-operations: configuring a dependency type; configuring a work item as a dependent object; and selecting, from the dependent object, a sub-object as a dependency item.

Optionally, the dependency type may include but is not limited to at least one of the following types: the current sub-object is allowed to be started when the dependency item is started, the current sub-object is allowed to be completed when the dependency item is started, the current sub-object is allowed to be started when the dependency item is completed, and the current sub-object is allowed to be completed when the dependency item is completed.

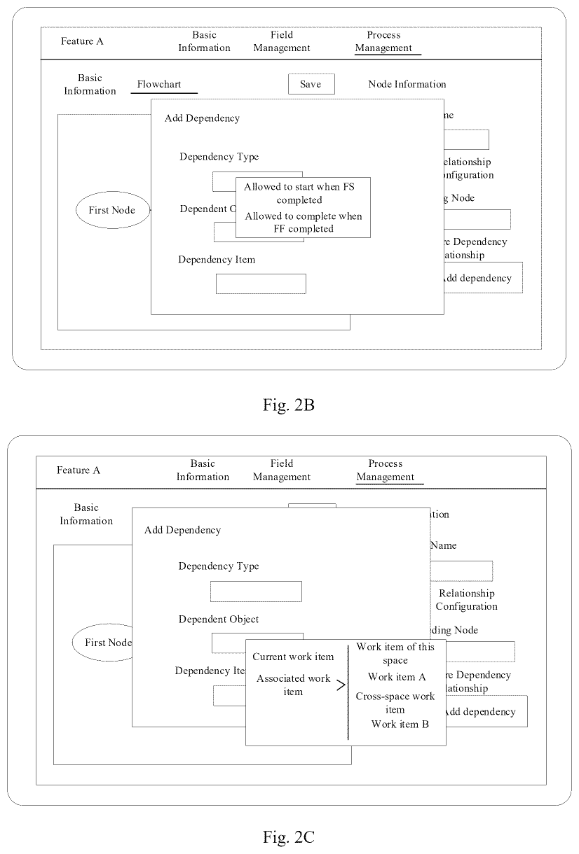

For example, reference is made to FIG. 2A, FIG. 2B, FIG. 2C, and FIG. 2D.

FIG. 2A shows a dependency configuration interface. For example, the dependency configuration interface may be displayed based on triggering an addition of a dependency control in a configuration interface on a project management side. It may be understood that it may also be displayed based on triggering an addition of a dependency control on an instance side (for example, a work item details page). In the dependency configuration interface, a dependency type, a dependent object, and a dependency item may be configured. The dependency item is a sub-object (for example, a sub-process node or a task) in the dependent object.

Reference is made to FIG. 2B. FIG. 2B shows a configured dependency type. A plurality of dependency types may be provided in a dependency type control for selection.

In some embodiments, configuring the work item as the dependent object includes: displaying candidate work item information; and determining, in response to a selection operation for the candidate work item information, a work item as the dependent object, wherein the candidate work item information includes first work item information and/or associated work item information of the first work item, and the associated work item information includes a work item of a first project space to which the first work item belongs and/or a work item of a second project space.

In some embodiments, displaying the candidate work item information includes: if the associated work item information includes a work item of the first project space and the work item of the second project space, displaying the associated work item information by project space grouping.

Reference is made to FIG. 2C. FIG. 2C shows a configured dependent object. The dependent object may be a current work item or an associated work item of the current work item. The associated work item may be a work item in the current space (for example, work item A), or may be a cross-space work item. When the selectable range of the dependent object is only the work item in the current space, grouping is not required. When the selectable range of the dependent object is the work item in the current space and the cross-space work item, different work items in different spaces are identified (for example, the work item in the current space and the cross-space work item are divided into two groups as shown in FIG. 2C), to facilitate viewing and selection by a user during usage.

In other words, a selection range of the dependent object is preset, and all work items in a current space associated with a current work item include a work item pushed from an external space to the current space and associated with the current work item. It should be noted that if it is a cross-space work item, an optional work item type range is a work item type authorized for the current space by an external work item.

In this way, the dependence of the first sub-object on a sub-object in the current work item or another work item can be implemented. The other work item may be a work item of a current project or another project, the range of objects that the first sub-object can depend on is expanded, and automatic and accurate management of the startup or completion of the first sub-object is implemented.

In some embodiments, the dependent object may be data of any work item, all data that a user has permission to access may be searched, and matching is performed according to an instance name. For example, a node flow work item, data in the current space that the user has permission to access, and an instance that is cross-space authorized to the current space and the currently logged-in user has permission.

Reference is made to FIG. 2D. FIG. 2D shows a configuration of dependency item. The dependency item may be a sub-process node or a subtask in the dependent object. For example, FIG. 2D shows a plurality of selectable options of the dependency item, such as a start node, a front-end node, a cross-test node, and an online node.

In some embodiments, the method further includes: performing loop check on the to-be-established dependency relationship in response to the dependency configuration operation; and establishing the dependency relationship in response to the check being passed, wherein the loop check includes that a superior dependent object of the second sub-object does not include the first sub-object. The superior dependent object may be a direct dependent object or an indirect dependent object.

For example, loop check is performed on a dependent object that is a work item in the current space. A same dependency chain cannot be connected end to end. Node A-Node B-Node C-Node A is not valid; Node A-Node B-Node A is not valid; and Node A-Task M-Node B is valid. All loop dependency detections should include a predecessor node.

For example, loop check is performed on a dependent object that includes a cross-space work item. Node a1 in Space A depends on Node a1 in Space B, and Node b1 in Space B depends on Node a1 in Space A. This is not valid. Node a1 in Space A depends on Node c1 in Space C, Node c1 in Space C depends on Node b1 in Space B, and Node b1 depends on Node a1 in Space A. This is not valid.

It may be understood that the same applies to task dependency in the current space or cross-space.

In this way, whether there is an error in the to-be-established dependency relationship can be checked before the dependency relationship is established, to avoid an error in project promotion caused by establishing an incorrect dependency relationship.

In some embodiments, the method further includes one or more of the following: deleting the dependency relationship information in response to deleting the first sub-object of the first work item; and deleting the dependency relationship information in response to deleting the second sub-object of the second work item.

In some scenarios, the abnormal situation may include, for example, an association relationship field of the associated work item is deleted, a dependent work item type is deleted, a node in the dependent object is deleted, or a task in the dependent object is deleted. Correspondingly, when an abnormality occurs, the corresponding dependency relationship information is deleted.

In some scenarios, an association relationship field of the associated work item is deleted. This abnormality may include that the associated work item field is deleted, a dependent work item established based on a relationship is deleted, or a dependent work item established based on a relationship is disabled. The corresponding dependency on the dependency list is added with an abnormal icon. When the mouse hovers over the icon, text is displayed: The current dependency item is abnormal, and the dependency rule cannot take effect. After entering dependency editing, the dependent object is normally displayed with the set “work item type of the dependency item”, and an abnormal icon is added. Different text is displayed for different abnormal situations of the current abnormal point. The text is, for example, when the associated work item field is deleted: “The associated work item field is deleted, and the current dependency cannot take effect. Please select another dependent object”; when the dependent work item established based on the relationship is deleted: “The associated work item is deleted, and the current dependency cannot take effect. Please select another dependent object”; when the dependent work item established based on the relationship is disabled: “The associated work item is disabled, and the current dependency cannot take effect. Please select another dependent object”.

In some scenarios, the dependent work item type is deleted, which specifically may include: the dependent work item type is deleted. It may be understood that this situation does not include disabling a work item, because the instance is still there and can still be selected. The corresponding dependency on the dependency list is added with an abnormal icon. After entering dependency editing, the dependency item is added with an abnormal icon. When the mouse hovers over the icon, text is displayed: “The current dependency item is abnormal, and the dependency rule cannot take effect”. After entering dependency editing, the work item type set on the dependent object is displayed abnormally; when the work item type is deleted, the abnormal icon and text (for example, the work item type has been deleted) are displayed; when the mouse hovers over the icon, the text (for example, the work item type has been deleted, and the current dependency cannot take effect. Please select another dependent object) is displayed.

In some scenarios, a node/task in the dependency item is deleted, which specifically may include that an abnormality includes that a node in the dependency item is deleted or a task in the dependency item is deleted. The corresponding dependency on the dependency list is added with an abnormal icon. When the mouse hovers over the icon, text is displayed (for example, the current dependency item is abnormal, and the dependency rule cannot take effect). After entering dependency editing, the node or task set in the dependency item is added with abnormal display; when the node is deleted, the abnormal icon and text (for example, the node has been deleted. Please select another dependent object) are displayed. When the task is deleted, the abnormal icon and text (for example, the task has been deleted. Please select another dependent object) are displayed.

In this way, a processing solution for abnormal situations can be provided, to avoid project progress being stuck due to the failure to delete the dependency relationship information in time.

In some embodiments, the method further includes: displaying a dependency relationship information list of the first sub-object in the first work item display interface, wherein the dependency relationship information list includes at least one of the following fields: a dependency item, a dependent object, and a dependency type.

In some embodiments, the display of the dependency relationship information may include various implementations.

In some embodiments, specific content of the dependency type is displayed in response to a trigger operation for the dependency type.

In some embodiments, if there is no permission to operate, the dependency addition control and the dependency deletion control are not displayed.

In some embodiments, if an instance is a cross-space instance, a space name and a work item type are displayed beside an instance name; and a space linkage dependency is also displayed in an overall dependency area.

In some embodiments, it is supported to add a dependency from more operations of a task. If the task has a dependency, an addition of a dependency button is displayed. If the task does not contain a deliverable, a deliverable viewing button is hidden. If the task contains a deliverable, the viewing button is displayed. After clicking, a display pop-up window of the deliverable pops up.

In some embodiments, operations or display styles of a node and a task may be distinguished according to the status of the node or the task.

In some embodiments, if a predecessor node has been completed and a dependency item is not completed, a node flow button is grayed out, and it is displayed that the current node contains an uncompleted dependency item. If the current node is a node confirmed by a plurality of persons, before the dependency is completed, all node persons in charge cannot click to complete, and the completion operation of each person in charge is disabled. Text is displayed, for example, the current node contains an uncompleted dependency item.

In some embodiments, a node or task in a dependency is displayed and takes effect when visibility is satisfied or the node or task is not deleted. When the node or task on which the dependency depends is deleted or visibility is not satisfied, the corresponding dependency item in the node is not displayed and does not take effect. If the node is automatically completed, when the node or task on which the dependency depends does not satisfy visibility (or is deleted) and there is no other dependency item, the current node is automatically completed. When the node or task on which the dependency depends appears again and visibility is satisfied, a manually added corresponding dependency node or task on an instance is automatically displayed and takes effect as long as it is not manually deleted; a preset corresponding dependency node or task on the instance is automatically displayed and takes effect as long as it is not manually deleted. When the node or task that appears again (visibility is satisfied or the node or task is restored) is an FS dependency and a corresponding node or task is not completed; if the current node has not arrived, a status of should arrive but not arrive is displayed after the current node arrives; if the current node has started or ended, the status of the node does not need to be rolled back; however, if the node is rolled back, when the node flows to the current node, the status of the current node is displayed as should arrive but not arrive according to the FS dependency. When the node or task that appears again (visibility is satisfied or the node or task is restored) is an FF dependency and a corresponding node or task is not completed; after the current node arrives, the completion operation of the node is restricted according to the completion dependency; if the current node has been completed, the status of the node does not need to be rolled back; however, if the node is rolled back, when the node flows to the current node, the completion operation of the node is restricted according to the FF dependency.

In some embodiments, a preset dependency takes effect only when a field of an associated work item is valid or is not deleted. Because the preset dependency needs to be established based on an instance value filled in the field of the associated work item, when the field is invalid or the field is deleted from a configuration side, the dependency item is not displayed and does not take effect. If the node is automatically completed and a work item node on which the dependency depends is ineffective due to the invalidity or deletion of the field of the associated work item, and there is no other dependency item, the current node is automatically completed. If the field changes from invalid to valid, the preset dependency is normally displayed and takes effect. Validity is not equal to a display condition. If the field does not meet the display condition but the field is valid, the field takes effect, and a corresponding dependency rule is valid.

In some embodiments, a calculation manner of an automatically completed node may include completion in space linkage, automatic completion in a node setting, and completion of a dependency item. After all the foregoing contents are completed, the node can be automatically completed.

In some embodiments, a node may be displayed in association with a dependency icon. The dependency icon may have different display forms according to different node status.

In some embodiments, the method further includes: displaying, in association with the sub-object of the first work item, a status indication identifier.

Herein, the status indication identifier includes at least one of the following: a first indication identifier, a second indication identifier, and a third indication identifier.

Optionally, the first indication identifier indicates a status that should be open but is not open due to the dependent item (for example, a hollow yellow circle) is not completed; the second indication identifier indicates an in-progress status (for example, a yellow solid circle); and the third indication identifier indicates a completed status (for example, a green solid circle).

In some embodiments, if the first indication identifier (for example, a hollow yellow circle) is displayed on a node, it may be that the node should arrive but not arrive, all predecessor nodes have been completed, and the remaining current node cannot be affected by a start dependency and cannot be started.

In some scenarios, the status indication identifier may be displayed in a place where the node is identified. For example, a node title of a node card, a node information option, node information displayed in a view control, WBS schedule in a details page, node information displayed in a swim lane diagram, and node information displayed in other applications that reference a work item.

In some embodiments, the method further includes: in response to a preset dependency switch being turned on, displaying a dependency addition control and displaying added dependency relationship information on a configuration side and/or an instance side of the first work item; and in response to the preset dependency switch being turned off, stopping displaying the dependency addition control and stopping displaying the added dependency information.

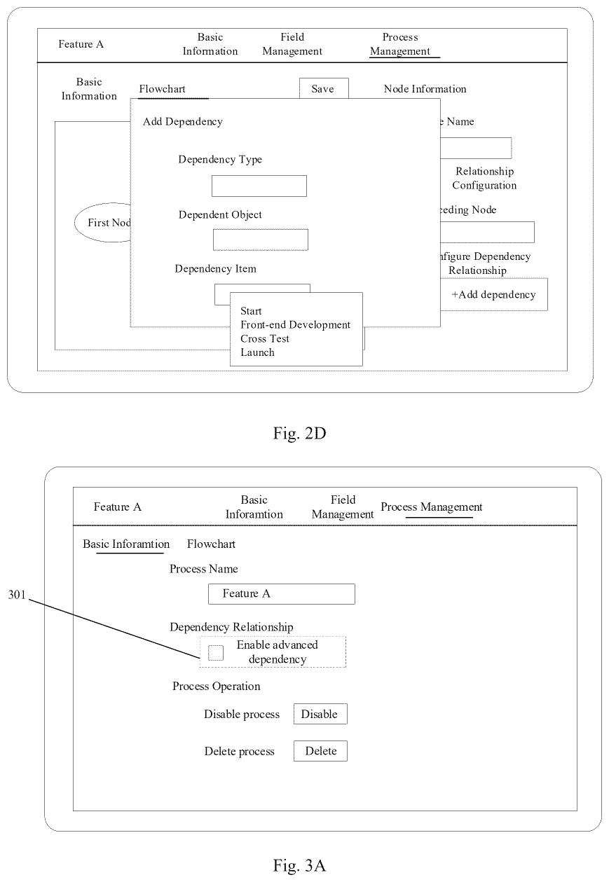

Reference is made to FIG. 3A. FIG. 3A shows that in a work item configuration interface, in a basic information configuration process in process management, whether to enable configuration and display of a dependency relationship of a work item may be selected by using a dependency switch 301.

For example, a space administrator (who may be an administrator of a single project or an administrator of a collection of a plurality of projects) may configure whether to support enabling a dependency. For example, as shown in FIG. 3A, on the configuration side, in basic information configuration of a flowchart, a setting item of an advanced dependency (namely, the dependency switch 301) is displayed; after the advanced dependency is enabled, a dependency item in the process may be predefined in the configuration, or a dependency may be added or deleted flexibly on a user side. A node/task may be started or completed according to the completion of the dependency item. When the advanced dependency is enabled or disabled, a secondary confirmation pop-up window may pop up for confirmation. If the advanced dependency is enabled, cross-level dependency relationships, including a start dependency and a completion dependency, may be supported to be configured in the process and in an associated work item control. After the advanced dependency is enabled, a dependency item module automatically appears in a form of the node or the subtask. If the advanced dependency is disabled, the dependency setting in the flowchart setting is hidden, a dependency group of the node on the instance is hidden, a task group on the instance is hidden, and an entry for adding a dependency to the task on the instance is hidden.

In some embodiments, after the dependency switch is turned off and the operation of turning off is saved, when the dependency switch is turned on again, configuration on an original node does not need to be restored.

In this way, a personalized relationship of whether to enable establishment of dependency relationship information for each work item can be implemented. If a dependency is not required to be enabled in the work item, the dependency addition control is not displayed, the number of controls displayed in the interface is reduced, and the simplicity of the interface is improved. If a dependency is required to be enabled in the work item, the dependency addition control is displayed, and automatic management of the start or completion of the sub-object is improved.

In some embodiments, the method further includes: displaying a flowchart of the first work item and a first dependency addition control in a first work item configuration interface of the project management system; and displaying, when a first sub-process node in the flowchart is in a selected status, a first dependency configuration interface in response to a trigger operation for the first dependency addition control, wherein the first dependency configuration interface is configured to receive the dependency configuration operation for adding the dependency relationship to the first sub-process node.

For example, reference is made to FIG. 3B and FIG. 3C. FIG. 3B shows that in a work item configuration interface, in a flowchart configuration process in process management, a dependency relationship may be added for a sub-process node. When any sub-process node in the flowchart is in a selected status, a dependency relationship may be configured for the selected sub-process. For example, when a second node is in the selected status, a dependency addition control 301 in FIG. 3B is triggered, and a dependency configuration interface shown in FIG. 2A may be displayed. Through the configuration operation in the dependency configuration interface, dependency relationships shown in FIG. 3C, for example, FS-node A (that is, the second node depends on the node A of the second work item, and the type is that the second node is allowed to be started when the node A is completed) and FF-node B (that is, the second node depends on the node B of the second work item, and the type is that the second node is allowed to be completed when the node B is completed), may be configured.

When the dependency relationship information is displayed in the work item configuration interface shown in FIG. 3C, if a dependent object is a node of the current work item, the process and the node name are not displayed. If the dependent object is not a node of the current work item, a work item and a work item type need to be displayed for a cross-work item.

In some embodiments, a dependency set for a current node and a dependency of the current node set through a linkage relationship in space linkage may be displayed. A dependency item of the node may be deleted and edited. A dependency item of the space linkage cannot be edited or deleted and can only be viewed herein.

In some embodiments, a dependency operation permission, for example, a permission to create a new dependency or delete a dependency, may be authorized to a role within a preset range. For example, a space administrator, a business line administrator, a business line super administrator, or a person in charge.

In some embodiments, when the dependency relationship information is displayed, a plurality of pieces of dependency relationship information may be displayed in ascending order of an addition time, a newly added dependency for a single time is ranked last, and an order of dependencies may be manually dragged.

In some embodiments, a subtask of the work item is configured in the work item configuration interface. A dependency addition control may be displayed in a task configuration interface of the subtask. The dependency addition control is triggered to pre-configure a dependency for the subtask.

In some embodiments, a dependency type of the task may only be selected as an FF completion dependency, and a start dependency is not supported to be set.

In some embodiments, in a WBS (Work Breakdown Structure) schedule, a setting of a task is consistent with an interactive interface of a node.

In some embodiments, dependency selection in a dependency relationship setting pop-up window of the task is consistent with that of the node. If there is a cross-space dependency item, work items are displayed by space grouping.

In this way, dependency configuration can be implemented from the dimension of work item management, and the concentration degree of sub-object management is improved.

In some embodiments, the method further includes: displaying a flowchart of the first work item and a second dependency addition control in a first work item details page of the project management system; and displaying, when a second sub-process node in the flowchart is in a selected status, a second dependency configuration interface in response to a trigger operation for the second dependency addition control, wherein the second dependency configuration interface is configured to receive the dependency configuration operation for adding the dependency relationship to the second sub-process node.

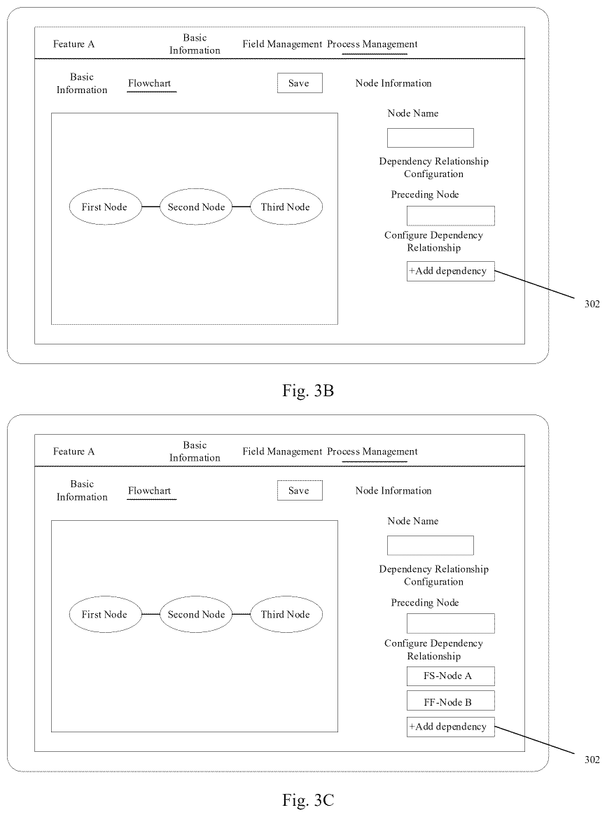

For example, reference is made to FIG. 4A and FIG. 4B. FIG. 4A and FIG. 4B show display of dependency relationship information of a sub-object in a details page of a work item (an instance side of the work item).

In FIG. 4A, display of dependency relationship information of a sub-process node of a first work item (for example, requirement A) is shown. In FIG. 4A, a dependency addition control 401 may be displayed. The dependency addition control 401 is triggered to display the dependency configuration interface shown in FIG. 2A.

In this way, adding a dependency relationship for a sub-process node can be implemented on the instance side of the work item in project management, and the convenience of sub-process management is improved.

In some embodiments, the method includes: displaying a third dependency addition control in a first subtask information configuration interface in the project management system; and displaying a third dependency configuration interface in response to a trigger operation for the third dependency addition control, wherein the third dependency configuration interface is configured to receive the dependency configuration operation for adding the dependency relationship to the first subtask.

In FIG. 4B, display of dependency relationship information of a subtask (for example, task A) of a first work item (for example, requirement A) is shown. In FIG. 4B, a task addition control 402 may be displayed. The task addition control 402 is triggered to display a task configuration interface shown in FIG. 4C. Task information, for example, a task name and a person in charge of the task, may be configured in the task configuration interface. A dependency addition control 403 may be displayed in the task configuration interface. The dependency addition control 403 is triggered to display the dependency configuration interface shown in FIG. 2A.

In this way, adding a dependency relationship for a subtask can be implemented on the instance side of the work item in project management, and the convenience of subtask management is improved.

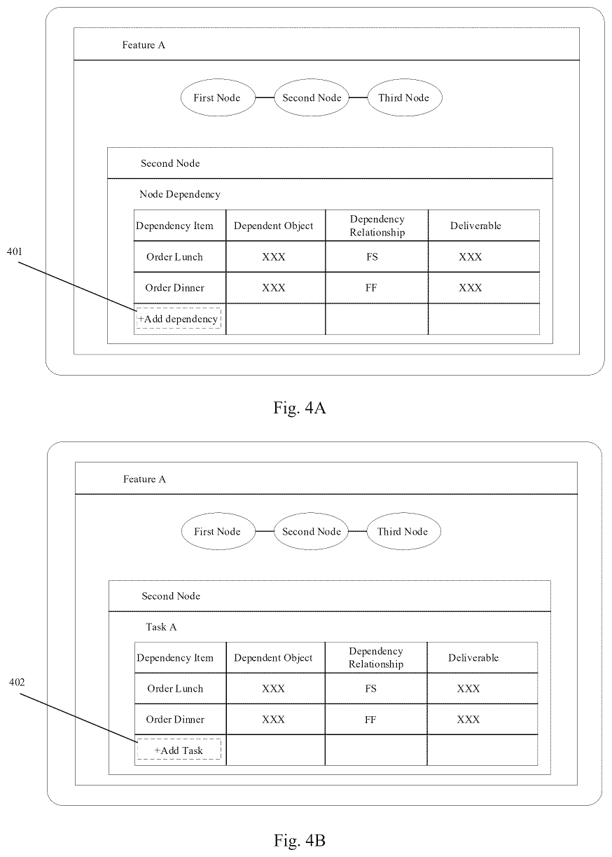

With further reference to FIG. 5, as an implementation of the method shown in the foregoing figures, the present disclosure provides an embodiment of an information processing apparatus. This apparatus embodiment corresponds to the method embodiment shown in FIG. 1. This apparatus may be specifically applied to various electronic devices.

As shown in FIG. 5, the information processing apparatus in this embodiment includes: an establishment unit 501 and a display unit 502. The establishment unit is configured to establish, in a project management system, a dependency relationship between a first sub-object of a first work item and a second sub-object of a second work item based on a dependency configuration operation. The display unit is configured to display, in a first work item display interface, dependency relationship information indicating the dependency relationship, wherein the dependency relationship is used to represent that opening or completion of the first sub-object depends on a status of the second sub-object.

In this embodiment, a specific process performed by the establishment unit 501 and the display unit 502 of the information processing apparatus and a technical effect brought about by the process may refer to related descriptions of Step 101 and Step 102 in the corresponding embodiment shown in FIG. 1 and are not described herein again.

In some embodiments, the dependency configuration operation includes at least one of the following sub-operations: configuring a dependency type; configuring a work item as a dependent object; and selecting, from the dependent object, a sub-object as a dependency item.

In some embodiments, the configuring a work item as a dependent object includes: displaying candidate work item information; and determining, in response to a selection operation for the candidate work item information, a work item as the dependent object, wherein the candidate work item information includes first work item information and/or associated work item information of the first work item, and the associated work item information includes a work item in a first project space to which the first work item belongs and/or a work item in a second project space.

In some embodiments, the displaying candidate work item information includes: if the associated work item information includes a work item in the first project space and a work item in the second project space, displaying the associated work item information in groups according to project spaces.

In some embodiments, the first sub-object includes a sub-process node and/or a subtask of the first work item; and the second sub-object includes a sub-process node and/or a subtask of the second work item.

In some embodiments, the apparatus is further configured to perform one or more of the following: deleting the dependency relationship information in response to deleting the first sub-object of the first work item; and deleting the dependency relationship information in response to deleting the second sub-object of the second work item.

In some embodiments, the apparatus is further configured to: perform loop check on the to-be-established dependency relationship in response to the dependency configuration operation; and establish the dependency relationship in response to the check being passed, wherein the loop check includes that a superior dependent object of the second sub-object does not include the first sub-object.

In some embodiments, the apparatus is further configured to: in response to a preset dependency switch being turned on, display a dependency addition control and display added dependency relationship information in the first work item display interface; and in response to the preset dependency switch being turned off, stop displaying the dependency addition control and stop displaying the added dependency relationship information.

In some embodiments, the apparatus is further configured to: display a flowchart of the first work item and a first dependency addition control in a first work item configuration interface of the project management system; and display a first dependency configuration interface in response to a trigger operation for the first dependency addition control when a first sub-process node in the flowchart is in a selected status, wherein the first dependency configuration interface is configured to receive the dependency configuration operation for adding the dependency relationship to the first sub-process node.

In some embodiments, the apparatus is further configured to: display a flowchart of the first work item and a second dependency addition control in a first work item details page of the project management system; and display a second dependency configuration interface in response to a trigger operation for the second dependency addition control when a second sub-process node in the flowchart is in a selected status, wherein the second dependency configuration interface is configured to receive the dependency configuration operation for adding the dependency relationship to the second sub-process node.

In some embodiments, the apparatus is further configured to: display a third dependency addition control in a first subtask information configuration interface in the project management system; and display a third dependency configuration interface in response to a trigger operation for the third dependency addition control, wherein the third dependency configuration interface is configured to receive the dependency configuration operation for adding the dependency relationship to the first subtask.

In some embodiments, the apparatus is further configured to: display a dependency relationship information list of the first sub-object in the first work item display interface, wherein the dependency relationship information list includes at least one of the following fields: a dependency item, a dependent object, and a dependency type.

In some embodiments, the apparatus is further configured to: display, in association with the sub-object of the first work item, a status indication identifier, wherein the status indication identifier includes at least one of the following: a first indication identifier, a second indication identifier, and a third indication identifier; and the first indication identifier indicates a status that should be open but is not open due to an incomplete dependency item; the second indication identifier indicates an in-progress status; and the third indication identifier indicates a completed status.

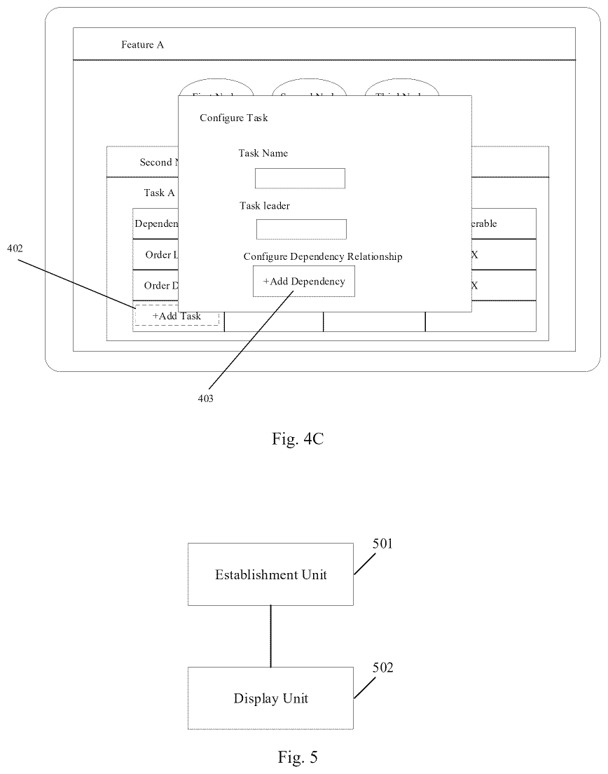

Reference is made to FIG. 6, which shows an example system architecture to which an information processing method according to an embodiment of the present disclosure may be applied.

As shown in FIG. 6, the system architecture may include terminal devices 601, 602, and 603, a network 604, and a server 605. The network 604 is configured to provide a medium for a communication link between the terminal devices 601, 602, and 603 and the server 605. The network 604 may include various connection types, for example, a wired or wireless communication link or an optical fiber cable.

The terminal devices 601, 602, and 603 may interact with the server 605 through the network 604 to receive or send messages and the like. Various client applications, for example, a web browser application, a search application, and a news information application, may be installed on the terminal devices 601, 602, and 603. The client applications on the terminal devices 601, 602, and 603 may receive an instruction from a user, and complete a corresponding function according to the instruction from the user, for example, add corresponding information to information according to the instruction from the user.

The terminal devices 601, 602, and 603 may be hardware or software. When the terminal devices 601, 602, and 603 are hardware, they may be various electronic devices with a display screen and supporting web browsing, including but not limited to a smart phone, a tablet computer, an e-book reader, an MP3 (Moving Picture Experts Group Audio Layer III) player, an MP4 (Moving Picture Experts Group Audio Layer IV) player, a laptop computer, and a desktop computer. When the terminal devices 601, 602, and 603 are software, they may be installed in the foregoing enumerated electronic devices. They may be implemented as multiple software or software modules (for example, software or software modules that provide distributed services), or may be implemented as a single software or software module. This is not specifically limited herein.

The server 605 may be a server that provides various services, for example, receives an information acquisition request sent by the terminal devices 601, 602, and 603, and acquires display information corresponding to the information acquisition request in various manners based on the information acquisition request. The server 605 then sends related data of the display information to the terminal devices 601, 602, and 603.

It should be noted that the information processing method provided in the embodiments of the present disclosure may be performed by the terminal devices, and correspondingly, the information processing apparatus may be provided in the terminal devices 601, 602, and 603. In addition, the information processing method provided in the embodiments of the present disclosure may also be performed by the server 605, and correspondingly, the information processing apparatus may be provided in the server 605.

It should be understood that the numbers of terminal devices, networks, and servers in FIG. 6 are merely illustrative. According to the implementation requirements, there may be any number of terminal devices, networks, and servers.

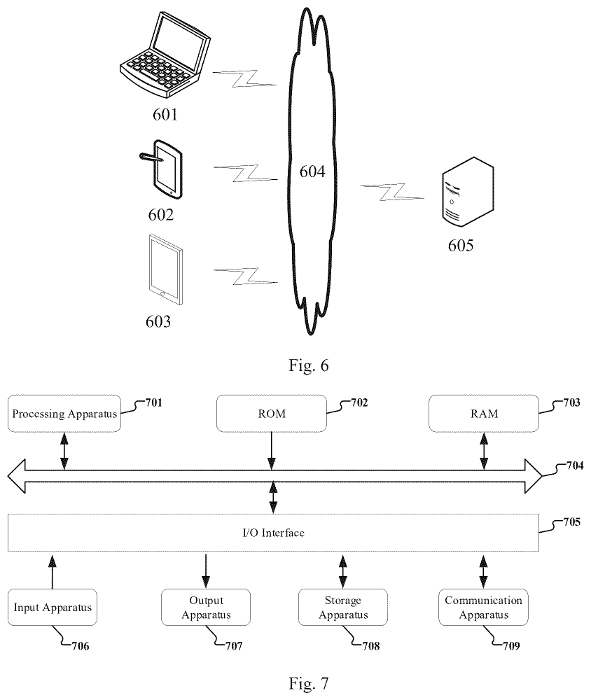

Reference is now made to FIG. 7, which shows a schematic structural diagram of an electronic device (for example, a terminal device or a server in FIG. 6) suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device may include a processing apparatus (for example, a central processing unit, a graphics processing unit, etc.) 701 that may perform various appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touch screen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device to perform wireless or wired communication with other devices to exchange data. Although FIG. 7 shows the electronic device having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 709 and installed, installed from the storage apparatus 708, or installed from the ROM 702. When the computer program is executed by the processing apparatus 701, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various modes, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a hypertext transfer protocol (HTTP), and can be connected to digital data communication (for example, a communication network) in any mode or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the foregoing electronic device. Alternatively, the computer-readable medium may exist independently, without being assembled into the electronic device.

The above computer-readable medium carries one or more programs that, when executed by the electronic device, cause the electronic device to: establish, in a project management system, a dependency relationship between a first sub-object of a first work item and a second sub-object of a second work item based on a dependency configuration operation; and display, in a first work item display interface, dependency relationship information indicating the dependency relationship, wherein the dependency relationship is used to represent that opening or completion of the first sub-object depends on a status of the second sub-object.

The computer program code for performing the operations in the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases, for example, a display unit may also be described as “a unit for displaying dependency relationship information”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The foregoing descriptions are merely preferred embodiments of the present disclosure and an explanation of the applied technical principles. A person skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features having similar functions disclosed in the present disclosure (but not limited thereto).

In addition, although various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments may also be implemented in combination in a single embodiment. In contrast, various features described in the context of a single embodiment may also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms of implementing the claims.

1. An information processing method, comprising:
establishing, in a project management system, a dependency relationship between a first sub-object of a first work item and a second sub-object of a second work item based on a dependency configuration operation; and
displaying, in a first work item display interface, dependency relationship information indicating the dependency relationship, wherein the dependency relationship is used to represent that opening or completion of the first sub-object depends on a status of the second sub-object.

2. The method according to claim 1, wherein the dependency configuration operation comprises at least one of the following sub-operations:
configuring a dependency type;
configuring a work item as a dependent object; and
selecting, from the dependent object, a sub-object as a dependency item.

3. The method according to claim 2, wherein the configuring a work item as a dependent object comprises:
displaying candidate work item information; and
determining, in response to a selection operation for the candidate work item information, a work item as the dependent object,
wherein the candidate work item information comprises first work item information and/or associated work item information of the first work item, and the associated work item information comprises a work item of a first project space to which the first work item belongs and/or a work item of a second project space.

4. The method according to claim 3, wherein the displaying candidate work item information comprises:
if the associated work item information comprises the work item of the first project space and the work item of the second project space, displaying the associated work item information by project space grouping.

5. The method according to claim 1, wherein
the first sub-object comprises a sub-process node and/or a subtask of the first work item; and
the second sub-object comprises a sub-process node and/or a subtask of the second work item.

6. The method according to claim 1, further comprising one or more of the following:
deleting the dependency relationship information in response to deleting the first sub-object of the first work item; and
deleting the dependency relationship information in response to deleting the second sub-object of the second work item.

7. The method according to claim 1, wherein the method further comprises:
performing loop check on the to-be-established dependency relationship in response to the dependency configuration operation; and
establishing the dependency relationship in response to the check being passed,
wherein the loop check comprises that a superior dependent object of the second sub-object does not comprise the first sub-object.

8. The method according to claim 1, further comprising:
in response to a preset dependency switch being turned on, displaying a dependency addition control and added dependency relationship information in the first work item display interface; and
in response to the preset dependency switch being turned off, stopping displaying the dependency addition control and the added dependency relationship information.

9. The method according to claim 1, further comprising:
displaying a flowchart of the first work item and a first dependency addition control in a first work item configuration interface of the project management system; and
displaying, when a first sub-process node in the flowchart is in a selected status, a first dependency configuration interface in response to a trigger operation for the first dependency addition control, wherein the first dependency configuration interface is configured to receive the dependency configuration operation for adding the dependency relationship to the first sub-process node.

10. The method according to claim 1, further comprising:
displaying a flowchart of the first work item and a second dependency addition control in a first work item details page of the project management system; and
displaying, when a second sub-process node in the flowchart is in a selected status, a second dependency configuration interface in response to a trigger operation for the second dependency addition control status, wherein the second dependency configuration interface is configured to receive the dependency configuration operation for adding the dependency relationship to the second sub-process node.

11. The method according to claim 1, further comprising:
displaying a third dependency addition control in a first sub-task information configuration interface in the project management system; and
displaying a third dependency configuration interface in response to a trigger operation for the third dependency addition control, wherein the third dependency configuration interface is configured to receive the dependency configuration operation for adding the dependency relationship to the first sub-task.

12. The method according to claim 1, further comprising:
displaying a dependency relationship information list of the first sub-object in the first work item display interface,
wherein the dependency relationship information list comprises at least one of the following fields: a dependency item, a dependent object, and a dependency type.

13. The method according to claim 1, further comprising:
displaying a status indication identifier in association with the sub-object of the first work item, wherein the status indication identifier comprises at least one of the following: a first indication identifier, a second indication identifier, and a third indication identifier, wherein
the first indication identifier indicates a status that should be open but is not open due to a dependency item is not completed;
the second indication identifier indicates an in-progress status; and
the third indication identifier indicates a completed status.

14. An information processing apparatus, comprising:
one or more processors; and
a non-transitory memory with instructions thereon,
wherein the instructions upon execution by the processor, cause the processor to:
establish, in a project management system, a dependency relationship between a first sub-object of a first work item and a second sub-object of a second work item based on a dependency configuration operation; and
display, in a first work item display interface, dependency relationship information indicating the dependency relationship, wherein the dependency relationship is used to represent that opening or completion of the first sub-object depends on a status of the second sub-object.

15. The apparatus according to claim 14, wherein the dependency configuration operation comprises at least one of the following sub-operations:
configuring a dependency type;
configuring a work item as a dependent object; and
selecting, from the dependent object, a sub-object as a dependency item.

16. The apparatus according to claim 15, wherein the processor is further caused to:
display candidate work item information; and
determine, in response to a selection operation for the candidate work item information, a work item as the dependent object,
wherein the candidate work item information comprises first work item information and/or associated work item information of the first work item, and the associated work item information comprises a work item of a first project space to which the first work item belongs and/or a work item of a second project space.

17. The apparatus according to claim 14, wherein the processor is further caused to:
display a flowchart of the first work item and a first dependency addition control in a first work item configuration interface of the project management system; and
display, when a first sub-process node in the flowchart is in a selected status, a first dependency configuration interface in response to a trigger operation for the first dependency addition control, wherein the first dependency configuration interface is configured to receive the dependency configuration operation for adding the dependency relationship to the first sub-process node.

18. The apparatus according to claim 14, wherein the processor is further caused to:
display a flowchart of the first work item and a second dependency addition control in a first work item details page of the project management system; and
display, when a second sub-process node in the flowchart is in a selected status, a second dependency configuration interface in response to a trigger operation for the second dependency addition control status, wherein the second dependency configuration interface is configured to receive the dependency configuration operation for adding the dependency relationship to the second sub-process node.

19. The apparatus according to claim 14, wherein the processor is further caused to:
display a third dependency addition control in a first sub-task information configuration interface in the project management system; and
display a third dependency configuration interface in response to a trigger operation for the third dependency addition control, wherein the third dependency configuration interface is configured to receive the dependency configuration operation for adding the dependency relationship to the first sub-task.

20. A non-transitory computer-readable storage medium storing instructions that cause at least a processor to:
establish, in a project management system, a dependency relationship between a first sub-object of a first work item and a second sub-object of a second work item based on a dependency configuration operation; and
display, in a first work item display interface, dependency relationship information indicating the dependency relationship, wherein the dependency relationship is used to represent that opening or completion of the first sub-object depends on a status of the second sub-object.
